(19) United States
(12) Patent Application Publication
(10) Pub. No.: US 2020/0017761 A1
(43) Pub. Date: Jan. 16, 2020

(54) POLYMERIC MATERIALS WITH THERMOCHROMIC PIGMENTS

(71) Applicant: Idea Glue LLC, New York, NY (US)

(72) Inventor: Lingbo Li, New York, NY (US)

(73) Assignee: Idea Glue LLC, New York, NY (US)

(21) Appl. No.: 16/510,241

(22) Filed: Jul. 12, 2019

Related U.S. Application Data
(60) Provisional application No. 62/697,154, filed on Jul. 12, 2018.

(51) Int. Cl. C09K 9/02; C08G 77/04; C08L 1/28; C09B 9/00; C08K 5/00; C08K 3/38; C08K 3/36; C08K 3/26; C08K 5/09; C08K 5/134; C08K 13/02

(52) U.S. Cl. CPC C09K 9/02; C08G 77/04; C08L 1/286; C09B 9/00; C08K 5/0041; C08K 3/38; C08K 2003/265; C08K 3/26; C08K 5/09; C08K 5/1345; C08K 13/02; C08L 2205/03; C08K 2003/387; C08K 3/36

(57) ABSTRACT

Compositions and methods related to polymeric materials with thermochromic pigments are generally described.

### RELATED APPLICATIONS

This Application claims priority under 35 U.S.C. § 119(e) of U.S. Provisional Application Serial No. 62/697,154, filed Jul. 12, 2018, entitled “POLYMERIC MATERIALS WITH THERMOCHROMIC PIGMENTS”, which is herein incorporated by reference in its entirety.

### TECHNICAL FIELD

Compositions and methods related to polymeric materials with thermochromic pigments are generally described.

### BACKGROUND

Silicone oil-based putties generally comprise organosilicone polymers, which are formed by covalent single bonds between a silicon atom and a heteroatom such as oxygen. More specifically, organosilicones have the empirical formula R₂SiO, and can be polymerized into chains with an alternating silicon-oxygen backbone having two alkyl groups bonded to each silicon atom. Silicones are viscoelastic materials that behave like viscous liquids at high temperatures and elastomers at low temperatures. The elastic behavior of silicones stems from the flexible silicon-oxygen bonds. Polymers of common organosilicones (e.g., polydimethylsiloxane) can be fine-tuned in terms of their physical properties by altering the number of repeat R₂SiO units in the polymeric chain, thereby providing fluids, emulsions, lubricants, resins, elastomers, and/or rubbers. The polymeric organosilicones can be crosslinked (e.g., with boric acid) to form Si—O—B linkages between polysiloxane chains, producing high molecular weight organosilicone polymers that are soft and pliable. Alternatively, water-based slimes generally comprise water and one or more organic polymers, such as polyvinyl alcohol, that are cross-linked by an activator, such as sodium borate. When dissolved in water, the activator interacts with the organic polymer chains, forming ionic bonds between the activator and the organic polymer. The water-based slimes are gelatinous viscoplastic compositions that behave like viscous liquids at high temperatures and plastics at low temperatures. Both the silicon oil-based polymeric compositions and water-based polymeric compositions can be doped with additives to provide silicone oil-based putties and water-based slimes with interesting properties.

### SUMMARY

Compositions and methods related to polymeric materials with thermochromic pigments are generally described.

Some embodiments described herein are related to a polymeric composition that has a first color at a first temperature, wherein the polymeric composition comprises a polymerized component, a first thermochromic pigment, a second thermochromic pigment, and a third thermochromic pigment. In certain embodiments, the first thermochromic pigment, second thermochromic pigment, and/or third thermochromic pigment cause the polymeric composition to have a second color at a second temperature, a third color and a third temperature, and/or a fourth color at a fourth temperature.

In some embodiments, a method of changing the color of a polymeric composition is described, the method comprising doping the polymeric composition with a first thermochromic pigment, a second thermochromic pigment, and a third thermochromic pigment, wherein the polymeric composition has a first color at a first temperature, and wherein the first thermochromic pigment, second thermochromic pigment, and/or third thermochromic pigment cause the polymeric composition to have a second color at a second temperature, a third color at a third temperature, and/or a fourth color at a fourth temperature. In certain embodiments, the method comprises changing the temperature so that the polymeric composition changes from the first color, to the second color, to third color, and/or to the fourth color.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is, according to some embodiments, a schematic drawing of a polymeric composition; and

FIG. 2 is, according to some embodiments, a flow chart describing a method of changing the color of a polymeric composition.

### DETAILED DESCRIPTION

Compositions and methods related to polymeric materials with thermochromic pigments are generally described. The polymeric composition may be a moldable compound. In certain embodiments, the polymeric composition comprises a polymerized component, such as a silicone oil or an organic polymer. In some cases, the polymeric composition comprising a silicone oil is an oil-based putty. In certain embodiments, the polymeric comprising an organic polymer is a water-based slime. Changes in temperature may cause the polymeric composition to change color due to various thermochromic pigments incorporated within the polymeric composition.

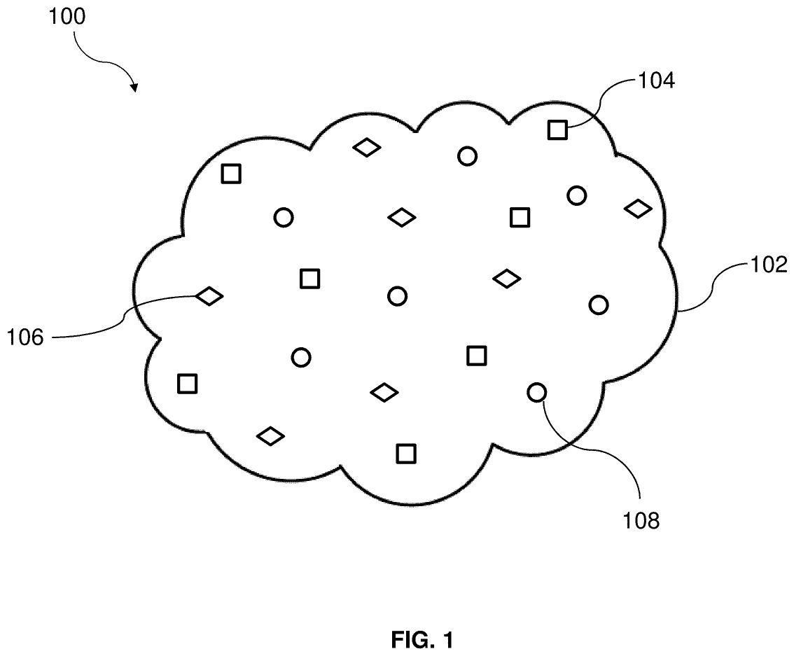

In certain aspects, the polymeric composition comprises more than two thermochromic pigments (e.g., three thermochromic pigments, four thermochromic pigments, etc.). FIG. 1 is, according to certain embodiments, a schematic drawing of a polymeric composition. As shown in FIG. 1, for example, polymeric composition 100 comprises first thermochromic pigment 104, second thermochromic pigment 106, and third thermochromic pigment 108. The thermochromic pigments may cause the polymeric composition to change color more than twice (e.g., three times, four times, etc.) upon exposing the polymeric composition to various temperatures. In some embodiments, the thermochromic pigments are leuco dyes. For example, referring to FIG. 1, in some embodiments, first thermochromic pigment 104, second thermochromic pigment 106, and/or third thermochromic pigment 108 are leuco dyes. As would be understood by a person of ordinary skill in the art, a leuco dye can generally be understood as a dye which has the ability to reversibly change between two chemical forms; one of which is colored, and the other of which is colorless. According to certain embodiments, the reversible change between the two chemical forms of a leuco dye is caused by changes in temperature. In certain embodiments, each leuco dye incorporated within the polymeric composition may change between the two chemical forms (e.g., colored and colorless) at different temperatures.

The first thermochromic pigment, second thermochromic pigment, and/or third thermochromic pigment may cause the polymeric composition to have a second color at a second temperature, a third color at a third temperature, and/or a fourth color at a fourth temperature, respectively. Certain embodiments are related to a method of changing the color in the polymeric composition, wherein the method comprises changing the temperature of the polymeric composition so that the polymeric composition changes from the first color to the second color, to the third color, and/or to the fourth color, which will be explained in greater detail below.

In certain embodiments, the polymeric composition has a first color at a first temperature. In some embodiments, the first color may be any of a variety of suitable colors that is visible by eye (e.g., black, white, red, orange, yellow, green, blue, indigo, violet, and/or combinations thereof). For example, in a non-limiting embodiment, the polymeric composition may have a black color at 20° C.

In some embodiments the first thermochromic pigment, second thermochromic pigment, and/or third thermochromic pigment may each contribute a portion of color to the first color of the polymeric composition. For example, in a non-limiting embodiment, the first leuco dye, second leuco dye, and/or third leuco dye may be combined in the polymeric composition, and each leuco dye may individually be in the chemical form that is colored at the first temperature. In some embodiments, the combination of colors of each leuco dye are perceived by the human eye as the first color.

In certain embodiments, at least one of the first thermochromic pigment, second thermochromic pigment, and/or third thermochromic pigment may be in the chemical form that is colorless at the first temperature. For example, in a non-limiting embodiment, the first leuco dye may be in the chemical form that is colorless at the first temperature, and both the second leuco dye and third leuco dye may be in the chemical form that is colored at the first temperature. In some such embodiments, only the second leuco dye and the third leuco dye contribute a portion of color to the first color. Any of a variety of suitable alternate embodiments are also possible (e.g., the second leuco dye is in the chemical form that is colorless at the first temperature and the first leuco dye and third leuco dye are in the chemical form that is colored at the first temperature, and the first leuco dye and third leuco dye contribute a portion of color to the first color at the first temperature).

According to some embodiments, the first temperature may be any of a variety of suitable temperatures. For example, the first temperature may be room temperature (e.g., in a range of 20° C. and 25° C.). In some cases, the first temperature may be average room temperature (e.g., 23° C.). In certain embodiments, the first temperature may be below room temperature (e.g., 0° C. to 20° C.). According to some embodiments, the polymeric composition may consistently retain the first color if the temperature of the polymeric composition is consistently at the first temperature.

According to certain embodiments, the color of the polymeric composition changes from the first color to the second color by changing the temperature of the polymeric composition from the first temperature to the second temperature. For example, the temperature of the polymeric composition may be raised from the first temperature (e.g., below room temperature or at room temperature) to a second temperature that is greater than the first temperature. In certain embodiments, the second temperature may be slightly higher than the first temperature. For example, the second temperature may be higher than the first temperature by 0.5° C., 1° C., 1.5° C., 2° C., 2.5° C., 3° C., 3.5° C., 4° C., 4.5° C., or 5° C., and so on.

The second color may be any of a variety of suitable colors that is visible by eye (e.g., black, white, red, orange, yellow, green, blue, indigo, violet, and/or combinations thereof). For example, in a non-limiting embodiment, the polymeric composition may have an orange color at 22° C. According to certain embodiments, the second color is a different color than the first color. In some cases, the polymeric composition may consistently retain the second color if the temperature of the polymeric composition is consistently at the second temperature.

According to certain embodiments, at least one of the first thermochromic pigment, second thermochromic pigment, and/or third thermochromic pigment may change from the chemical form that is colored to the chemical form that is colorless upon changing the temperature of the polymeric composition from the first temperature to the second temperature. In some embodiments, the one or more thermochromic pigments that are in the chemical form that is colored after changing the temperature from the first temperature to the second temperature each contribute a portion of color to the second color of the polymeric composition. In a non-limiting embodiment, the first leuco dye, second leuco dye, and third leuco dye may each individually be in the chemical form that is colored at the first temperature, and upon changing the temperature of the polymeric composition from the first temperature to the second temperature, the first leuco dye may change from the chemical form that is colored to the chemical form that is colorless. In such an embodiment, the second leuco dye and the third leuco dye each contribute a portion of color to the second color of the polymeric composition. Any of a variety of suitable alternate embodiments are also possible.

In certain embodiments, at least one of the first thermochromic pigment, second thermochromic pigment, and/or third thermochromic pigment may change from the chemical form that is colorless to the chemical form that is colored upon changing the temperature of the polymeric composition from the first temperature to the second temperature. In a non-limiting embodiment, the first leuco dye and second leuco dye may be each individually be in the chemical form that is colored at the first temperature, and third leuco dye may be in the chemical from that is colorless at the first temperature. Upon changing the temperature of the polymeric composition from the first temperature to the second temperature, the third leuco dye may change from the chemical form that is colorless to the chemical form that is colored. In such an embodiment, the first leuco dye, second leuco dye, and the third leuco dye may each contribute a portion of color to the second color of the polymeric composition.

Combinations are also possible wherein at least one of the first thermochromic pigment, second thermochromic pigment, and/or third thermochromic pigment change from the chemical form that is colored to the chemical form that is colorless, and at least one of the first thermochromic pigment, second thermochromic pigment, and/or third thermochromic pigment change from the chemical form that is colorless to the chemical form that is colored upon changing the temperature of the polymeric composition from the first temperature to the second temperature.

The second temperature may be any of a variety of suitable temperatures. In some embodiments, the second temperature is greater than the first temperature. In certain embodiments, the second temperature may be in a range of 20.5° C. to 30° C. According to some embodiments, the color of the polymeric composition changes from the first color to the second color by changing the temperature of the composition from the range of 20° C. to 25° C. to the range of 20.5° C. to 30° C. Such changes in the temperature of the composition may occur by exchanging heat with the human body to the polymeric composition (e.g., by holding the polymeric composition and/or enclosing a fist around the polymeric composition) or by exposing the polymeric composition to a heat source. For example, in some embodiments, the polymeric composition may be exposed to heat from the sun or radiation from a microwave. In certain embodiments, exposing the polymeric composition to a heat source may comprise removing the polymeric composition from a refrigerator at below room temperature and exposing the polymeric composition to room temperature.

In certain embodiments, the color of the polymeric composition changes from the second color to the third color by changing the temperature of the polymeric composition from the second temperature to the third temperature. For example, in certain embodiments, the temperature of the polymeric composition may be raised from the second temperature (e.g., slightly above room temperature) to a third temperature that is greater than the second temperature. In certain embodiments, the third temperature may be slightly greater than the second temperature. For example, the third temperature may be higher than the second temperature by 0.5° C., 1° C., 1.5° C., 2° C., 2.5° C., 3° C., 3.5° C., 4° C., 4.5° C., or 5° C., and so on.

According to certain embodiments, the third color may be any suitable color that is visible by eye (e.g., black, white, red, orange, yellow, green, blue, indigo, violet, and/or combinations thereof). For example, in a non-limiting embodiment, the polymeric composition may have a yellow color at 27° C. According to certain embodiments, the third color is a different color than the first color and/or second color. The polymeric composition may consistently retain the third color if the temperature of the polymeric composition is consistently at the third temperature.

According to certain embodiments, at least one of the first thermochromic pigment, second thermochromic pigment, and/or third thermochromic pigment may change from the chemical form that is colored to the chemical form that is colorless upon changing the temperature of the polymeric composition from the second temperature to the third temperature. In some embodiments, the one or more resultant thermochromic pigments that are in the chemical form that is colored after changing the temperature from the second temperature to the third temperature each contribute a portion of color to the third color of the polymeric composition. In a non-limiting embodiment, at the second temperature, the first leuco dye may be in the chemical form that is colorless, and both the second leuco dye and third leuco dye may each individually be in the chemical form that is colored. In such an embodiment, upon changing the temperature of the polymeric composition to the third temperature, the second leuco dye may change from the chemical form that is colored to the chemical form that is colorless, and the third leuco dye would contribute the third color of the polymeric composition. Any of a variety of suitable alternate embodiments are also possible.

In certain embodiments, at least one of the first thermochromic pigment, second thermochromic pigment, and/or the third thermochromic pigment may change from the chemical form that is colorless to the chemical form that is colored upon changing the temperature of the polymeric composition from the second temperature to the third temperature. For example, in a non-limiting embodiment, at the second temperature, the first leuco dye may be in the chemical form that is colorless, and both the second leuco dye and third leuco dye may be each individually be in the chemical form that is colored. In such an embodiment, upon changing the temperature of the polymeric composition to the third temperature, the first leuco dye may change from the chemical form that is colorless to the chemical form that is colored, and the first leuco dye, second leuco dye, and third leuco dye would contribute to the third color of the polymeric composition.

Combinations are also possible wherein at least one of the first thermochromic pigment, second thermochromic pigment, and/or third thermochromic pigment change from the chemical form that is colored to the chemical form that is colorless, and at least one of the first thermochromic pigment, second thermochromic pigment, and/or third thermochromic pigment change from the chemical form that is colorless to the chemical form that is colored upon changing the temperature of the polymeric composition from the second temperature to the third temperature.

The third temperature may be any of a variety of suitable temperatures. In some embodiments, the third temperature is greater than the second temperature. In certain embodiments, the third temperature may be in a range of 21° C. to 35° C. The color of the polymeric composition may change from the second color to the third color by changing the temperature of the polymeric composition from the range of 20.5° C. to 30° C. to the range of 21° C. to 35° C. Such changes in the temperature of the polymeric composition may occur from exchanging heat with the human body to the silicone oil-based putty (e.g., by holding the silicone oil-based putty and/or enclosing a fist around the polymeric composition) or by exposing the polymeric composition to a heat source (e.g., the sun, a microwave, etc.).

According to certain embodiments, the color of the polymeric composition changes from the third color to the fourth color by changing the temperature of the polymeric composition from the third temperature to the fourth temperature. For example, the temperature of the polymeric composition may be raised from the third temperature to a fourth temperature that is greater than the third temperature. In certain embodiments, the fourth temperature may be slightly higher than the third temperature.

For example, the fourth temperature may be higher than the third temperature by 0.5° C., 1° C., 1.5° C., 2° C., 2.5° C., 3° C., 3.5° C., 4° C., 4.5° C., or 5° C., and so on.

In some embodiments, the fourth color may be any of a variety of suitable colors that is visible by eye (e.g., black, white, red, orange, yellow, green, blue, indigo, violet, and/or combinations thereof). For example, in a non-limiting embodiment, the polymeric composition may have a blue color at 32° C. According to certain embodiments, the fourth color is a different color than the first color, second color, and/or third color.

According to certain embodiments, at least one of the first thermochromic pigment, second thermochromic pigment, and/or third thermochromic pigment may change from the chemical form that is colored to the chemical form that is colorless upon changing the temperature of the polymeric composition from the third temperature to the fourth temperature. In a non-limiting embodiment, at the third temperature, the first leuco dye and the second leuco dye may each individually be in the chemical form that is colorless, and third leuco dye may be in the chemical form that is colored, and upon changing the temperature of the polymeric composition to the fourth temperature, the third leuco dye may change from the colored form to the colorless form. In some such embodiments, for example, the fourth color of the polymeric composition may appear white to the human eye. Other embodiments are possible.

In certain embodiments, at least one of the first thermochromic pigment, second thermochromic pigment, and/or third thermochromic pigment may change from the chemical from that is colorless to the chemical form that is colored upon changing the temperature of the polymeric composition from the third temperature to the fourth temperature. For example, in a non-limiting embodiment, at the third temperature, the first leuco dye, second leuco dye, and third leuco dye may be each individually be in the chemical form that is colored. In such an embodiment, upon changing the temperature of the polymeric composition to the third temperature, both the first leuco dye and the second leuco dye may change from the chemical form that is colored to the chemical form that is colorless, and the third leuco dye would contribute to the fourth color of the polymeric composition.

Combinations are also possible wherein at least one of the first thermochromic pigment, second thermochromic pigment, and/or third thermochromic pigment change from the chemical form that is colored to the chemical form that is colorless, and at least one of the first thermochromic pigment, second thermochromic pigment, and/or third thermochromic pigment change from the chemical form that is colorless to the chemical form that is colored upon changing the temperature of the polymeric composition from the third temperature to the fourth temperature.

The fourth temperature may be any of a variety of suitable temperatures. In some aspects, the fourth temperature is greater than the third temperature. In certain embodiments, the fourth temperature may be in a range of 21.5° C. to 40° C. The color of the polymeric composition may change from the third color to the fourth color by changing the temperature of the polymeric composition from the range of 21° C. to 35° C. to the range of 21.5° C. to 40° C. Such changes in the temperature of the polymeric composition may occur from exchanging heat with the human body to the polymeric composition (e.g., by holding the polymeric composition and/or enclosing a fist around the polymeric composition) or by exposing the polymeric composition to a heat source (e.g., the sun, a microwave, etc.).

In some embodiments, the polymeric composition may change color from the first color, to the second color, and to the third color, by changing the temperature of the polymeric composition from the first temperature to the third temperature. For example, the polymeric composition may change from the first color, to the second color, and to the third color by slightly changing the temperature of the polymeric composition (e.g., in 1° C. increments) from the first temperature (e.g., 23° C.) to the third temperature (e.g., 25° C.). According to some embodiments, the polymeric composition may change from the first color, to the second color, and to the third color, by more than slightly changing the temperature of the polymeric composition (e.g., more than 1° C. increments). For example, the polymeric composition may change from the first color, to the second color, and to the third color by changing the temperature of the polymeric composition from the first temperature (e.g., 23° C.) to the third temperature (e.g., 33° C.). According to certain embodiments, the changes in color (e.g., from the first color, to the second color, and to the third color) of the polymeric composition may be continuous as the temperature of the polymeric composition is continuously changed (e.g., from the first temperature, to the second temperature, and to the third temperature).

In certain embodiments, the polymeric composition may change from the first color, to the second color, to the third color, and to the fourth color by changing the temperature of the polymeric composition from the first temperature to the fourth temperature. For example, the polymeric composition may change from the first color, to the second color, to the third color, and to the fourth color by slightly changing the temperature of the polymeric composition (e.g., in 1° C. increments) from the first temperature (e.g., 23° C.) to the fourth temperature (e.g., 26° C.). According to some embodiments, the polymeric composition may change from the first color, to the second color, to the third color, and to the fourth color by drastically changing the temperature of the polymeric composition (e.g., more than 1° C. increments). For example, the polymeric composition may change from the first color, to the second color, to the third color, and to the fourth color by changing the temperature of the polymeric composition from the first temperature (e.g., 23° C.) to the fourth temperature (e.g., 38° C.). According to certain embodiments, the changes in color (e.g., from the first color, to the second color, to the third color, and to the fourth color) in the polymeric composition may be continuous as the temperature of the polymeric composition is continuously changed (e.g., from the first temperature, to the second temperature, to the third temperature, and to the fourth temperature).

According to certain embodiments, the observed color changes from the first color, to the second color, to the third color, and/or to the fourth in the polymeric composition are reversible. Such changes in the temperature of the polymeric composition may occur, in certain embodiments, by cooling the temperature of the polymeric composition (e.g., by placing the polymeric composition in water, in a refrigerator, and/or on ice).

In certain embodiments, the color of the polymeric composition changes from the fourth color to the third color by changing the temperature of the polymeric composition from the fourth temperature to the third temperature. For example, in some embodiments, the color of the polymeric composition changes from the fourth color to the third color by decreasing the temperature of the polymeric composition from the range of 21.5° C. and 40° C. to the range of 21° C. and 35° C.

According to some embodiments, the color of the polymeric composition changes from the third color to the second color by changing the temperature of the polymeric composition from the third temperature to the second temperature. For example, in some embodiments, the color of the polymeric composition changes from the fourth color to the third color by decreasing the temperature of the polymeric composition from the range of 21° C. and 35° C. to the range of 20.5° C. and 30° C.

In some embodiments, the color of the polymeric composition changes from the second color to first color by changing the temperature of the polymeric composition from the second temperature to the first temperature. For example, in some embodiments, the color of the polymeric composition changes from the fourth color to the third color by decreasing the temperature of the polymeric composition from the range of 20.5° C. and 30° C. to the range of 20° C. and 25° C.

According to certain embodiments, the polymeric composition may change from the fourth color, to the third color, and to the second color by changing the temperature of the polymeric composition from the fourth temperature to the second temperature. According to some embodiments, the polymeric composition may change from the fourth color, to the third color, and to the second color, by changing the temperature of the polymeric composition from the range of 21.5° C. to 40° C. to the range of 20.5° C. to 30° C. For example, the polymeric composition may change from the fourth color, to the third color, and to the second color by slightly changing the temperature of the polymeric composition (e.g., in 1° C. increments) from the fourth temperature (e.g., 26° C.) to the second temperature (e.g., 24° C.). According to some embodiments, the polymeric composition may change from the fourth color, to the third color, and to the second color by drastically changing the temperature of the polymeric composition (e.g., more than 1° C. increments). For example, the polymeric composition may change from the fourth color, to the third color, and to the second color by changing the temperature of the polymeric composition from the fourth temperature (e.g., 38° C.) to the second temperature (e.g., 28° C.).

In some embodiments, the polymeric composition may change from the fourth color, to the third color, to the second color, and to the first color by changing the temperature of the polymeric composition from the fourth temperature to the first temperature. According to some embodiments, the polymeric composition may change from the fourth color, to the third color, to the second color, and to the first color by changing the temperature of the polymeric composition from the range of 21.5° C. to 40 ° C. to the range of 20° C. to 25° C. For example, the polymeric composition may change from the fourth color, to the third color, to the second color, and to the first color by slightly changing the temperature of the polymeric composition (e.g., in 1° C. increments) from the fourth temperature (e.g., 26° C.) to the first temperature (e.g., 23° C.). According to some embodiments, the polymeric composition may change from the fourth color, to the third color, to the second color, and to the first color by drastically changing the temperature of the polymeric composition (e.g., more than 1° C. increments). For example, the polymeric composition may change from the fourth color, to the third color, to the second color, and to the first color by changing the temperature of the polymeric composition from the fourth temperature (e.g., 38° C.) to the first temperature (e.g., 23° C.).

According to some embodiments, the polymeric composition comprises a polymerized component. Referring to FIG. 1, polymeric composition 100 comprises polymerized component 102. In certain embodiments, the polymerized component may comprise a silicone oil. According to certain embodiments, the silicone oil comprises a siloxane. As would generally be understood by a person ordinarily skilled in the art, a siloxane refers to an organosilicon functional group with a Si—O—Si linkage. For example, the silicone oil may comprise dimethylsiloxane.

The polymeric composition may comprise any of a variety of suitable silicone oils. For example, in certain embodiments, the silicone oil is a polymerized siloxane (e.g., a linear polymerized siloxane). According to some embodiments, the silicone oil is a liquid polymerized siloxane (e.g., a liquid linear polymerized siloxane). In some embodiments, the silicone oil may be a polydialkylsiloxane (e.g., polydimethylsiloxane). In certain embodiments, the silicone oil may be a polyalkylphenylsiloxane (e.g., polymethylphenylsiloxane).

The polymeric composition may comprise the silicone oil in any or a variety of suitable amounts. For example, according to certain embodiments, the polymeric composition comprises the silicone oil in a range of 50 wt. % to 95 wt. % versus the total weight of the composition. In certain embodiments, the polymeric composition comprises silicone oil in an amount of greater than or equal to 50 wt. %, greater than or equal to 60 wt. %, greater than or equal to 70 wt. %, greater than or equal to 80 wt. %, or greater than or equal to 90 wt. % versus the total weight of the composition. According to some embodiments, the polymeric composition comprises silicone oil in an amount of less than or equal to 95 wt. %, less than or equal to 90 wt. %, less than or equal to 80 wt. %, less than or equal to 70 wt. %, or less than or equal to 60 wt. % versus the total weight of the composition. Combinations of these ranges are also possible (e.g., greater than or equal to 50 wt. % and less than or equal to 95 wt. % versus the total weight of the composition, greater than or equal to 70 wt. % and less than or equal to 90 wt. % versus the total weight of the composition). Other ranges are also possible.

According to certain embodiments, the polymeric composition may further comprise boric acid. For example, according to certain embodiments, the polymeric composition comprising a silicone oil may further comprise boric acid. In certain embodiments, boric acid may be used to crosslink polymeric organosilicones to form Si—O—B linkages between polysiloxane chains. The composition may comprise boric acid in any or a variety of suitable amounts. For example, the composition may comprise boric acid in a range of 0.001 wt. % to 20 wt. % versus the total weight of the composition. In certain embodiments, the boric acid may be mixed with the silicone oil prior to, during, or after the addition of the first thermochromic pigment, the second thermochromic pigment, and/or the third thermochromic pigment.

According to certain embodiments, the polymeric composition comprising silicone oil is a polymeric silicone oil-based putty composition.

In certain embodiments, the polymerized component may comprise organic polymers. In some embodiments, the polymeric composition may comprise any of a variety of suitable organic polymers. For example, the composition may comprise polyvinyl alcohol, polyvinyl acetate, polysaccharide guar gum, methylcellulose, cornstarch, and/or derivatives thereof. In certain embodiments, the organic polymer may be a glue adhesive (e.g., Elmer's glue).

The polymeric composition may comprise the organic polymer in any or a variety of suitable amounts. For example, according to certain embodiments, the polymeric composition comprises the organic polymer in a range of 1 wt. % to 20 wt. % versus the total weight of the composition. In certain embodiments, the polymeric composition comprises the organic polymer in an amount of greater than or equal to 1 wt. %, greater than or equal to 1.5 wt. %, greater than or equal to 2 wt. %, greater than or equal to 3 wt. %, greater than or equal to 4 wt. %, greater than or equal to 5 wt. %, greater than or equal to 10 wt. %, or greater than or equal to 15 wt. % versus the total weight of the composition. According to some embodiments, the polymeric composition comprises the organic polymer in an amount of less than or equal to 20 wt. %, less than or equal to 15 wt. %, less than or equal to 10 wt. %, less than or equal to 5 wt. %, less than or equal to 4 wt. %, less than or equal to 3 wt. %, less than or equal to 2 wt. %, or less than or equal to 1.5 wt. % versus the total weight of the composition. Combinations of these ranges are also possible (e.g., greater than or equal to 1 wt. % and less than or equal to 15 wt. % versus the total weight of the composition, greater than or equal to 1.5 wt. % and less than or equal to 2 wt. % versus the total weight of the composition). Other ranges are also possible.

According to certain embodiments, the polymeric composition may further comprise water. For example, the polymeric composition comprising the organic polymer may further comprise water. The polymeric composition comprising the organic polymer may comprise water in any of a variety of suitable amounts. For example, the polymeric composition comprising the organic polymer may comprise water in an amount of 60 wt. % to 95 wt. % versus the total weight of the composition.

In some embodiments, the polymeric composition may further comprise an activator. For example, in some embodiments, the polymeric composition comprising the organic polymer may further comprise an activator. According to certain embodiments, the activator initiates cross-linking of the organic polymer (e.g., polyvinyl alcohol). In certain embodiments, the activator may be sodium borate (borax) and/or sodium tetraborate. The polymeric composition comprising the organic polymer may comprise the activator in any of a variety of suitable amounts. For example, the polymeric composition comprising the organic polymer may comprise the activator in an amount of 1 wt. % to 10 wt. % versus the total weight of the composition.

According to certain embodiments, the polymeric composition comprising an organic polymer, water, and an activator may be a polymeric water-based slime composition.

In certain embodiments, the polymeric composition has any of a variety of suitable physical properties. For example, according to certain embodiments, the polymeric composition has high thermal stability, such that the polymeric composition is resistant to high temperatures (e.g., 110° C., 120° C., 130° C., 140° C., 150° C., etc.). In some embodiments, the polymeric composition is resistant to low temperatures (e.g., 0° C., −10° C., −20° C., −30° C., −40° C., −50° C., etc.). According to certain embodiments, the polymeric composition may have any of the following properties: oxidation stability, chemical inertness, low flammability, low surface tension, low flammability, low surface tension, compressibility, shear stability, thermal conductivity, and/or small degrees of change in viscosity during temperature changes. According to some embodiments, the polymeric composition is non-corrosive.

In certain embodiments, the first thermochromic pigment, second thermochromic pigment, and/or third thermochromic pigment (e.g., leuco dyes) are reversible thermally induced discoloration materials. According to some embodiments, the first thermochromic pigment, second thermochromic pigment, and/or third thermochromic pigment comprise myristyl, palm alcohol, 2,2-two (4-hydroxy-phenyl), latent dye, and/or melamine epoxy polymer. According to certain embodiments, the first thermochromic pigment, second thermochromic pigment, and/or third thermochromic pigment comprises myristyl in an amount of 40 wt. % to 65 wt. %, palm alcohol in an amount of 20 wt. % to 40 wt. %, 2,2-two (4 hydroxy-phenyl) in an amount of 7 wt. % to 20 wt. %, latent dye in an amount of 3 wt. % to 9 wt. %, and/or melamine epoxy polymer in an amount of 13 wt. % to 35 wt. % versus the total composition of the first thermochromic pigment, second thermochromic pigment, and/or third thermochromic pigment.

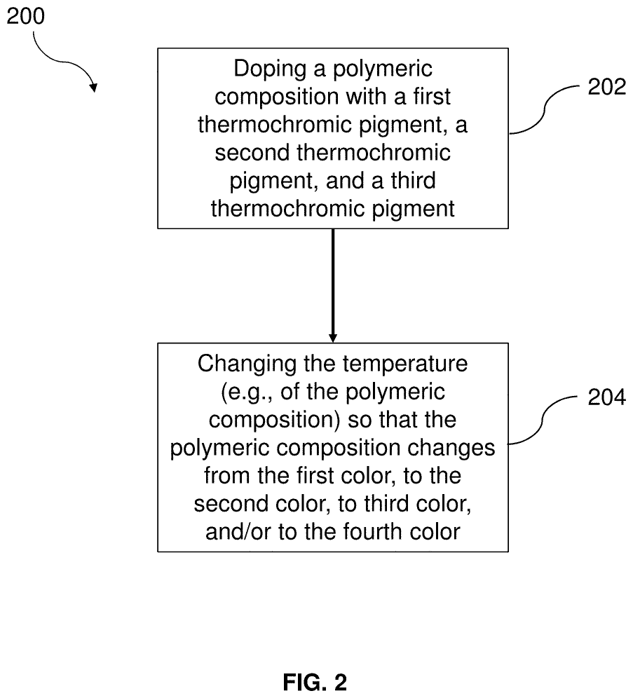

Certain embodiments are related to a method of changing the color of a polymeric composition. FIG. 2 is, according to certain embodiments, a flow chart describing a method of changing the color of a polymeric composition. As shown in FIG. 2, method 200 of changing the color of a polymeric composition comprises step 202 of doping a polymeric composition with a first thermochromic pigment, a second thermochromic pigment, and a third thermochromic pigment. In certain embodiments, the polymeric composition has a first color at a first temperature, and the first thermochromic pigment, second thermochromic pigment and/or third thermochromic pigment cause the polymeric composition to have a second color at a second temperature, a third color at a third temperature, and/or a fourth color at a fourth temperature. According to certain embodiments, the first thermochromic pigment, second thermochromic pigment, and/or third thermochromic pigment may be added to the polymeric composition by mixing the polymeric composition and the first thermochromic pigment, second thermochromic pigment, and/or third thermochromic pigment such that the first thermochromic pigment, second thermochromic pigment, and/or third thermochromic pigment is substantially evenly distributed throughout the polymeric composition.

Referring to FIG. 2, in certain embodiments, the method also comprises step 204 of changing the temperature of the polymeric composition so that the polymeric composition changes from the first color, to the second color, to third color, and/or to the fourth color. According to some embodiments, the temperature of the polymeric composition may be changed by any of a variety of suitable ways. For example, the temperature of the polymeric composition may be changed by exchanging heat with the human body (e.g., by holding the polymeric composition and/or enclosing a fist around the polymeric composition), by exposing the polymeric composition to a heat source (e.g., the sun, a microwave), by exposing the polymeric composition to a cold source (e.g., the refrigerator, an ice bath), etc.

The polymeric composition may comprise the first thermochromic pigment in any of a variety of suitable amounts. For example, in some embodiments, the polymeric composition comprises the first thermochromic pigment in a range of 0.1 wt. % to 10 wt. % versus the total weight of the composition. In certain embodiments, the polymeric composition comprises the first thermochromic pigment in an amount of greater than or equal to 0.1 wt. %, greater than or equal to 1 wt. %, greater than or equal to 2 wt. %, greater than or equal to 5 wt. %, or greater than or equal to 7 wt. % versus the total weight of the composition. According to some embodiments, the polymeric composition comprises the first thermochromic pigment in an amount of less than or equal to 10 wt. %, less than or equal to 7 wt. %, less than or equal to 5 wt. %, less than or equal to 2 wt. %, or less than or equal to 1 wt. % versus the total weight of the composition. Combinations of these ranges are also possible (e.g., the polymeric composition comprises the first thermochromic pigment in a range of greater than or equal to 1 wt. % and less than or equal to 7 wt. % versus the total weight of the composition, the polymeric composition comprises the first thermochromic pigment in a range of greater than or equal to 2 wt. % and less than or equal to 5 wt. % versus the total weight of the composition). Other ranges are also possible.

The polymeric composition may comprise the second thermochromic pigment in any of a variety of suitable amounts. For example, in certain embodiments, the polymeric composition comprises the second thermochromic pigment in a range of 0.1 wt. % to 10 wt. % versus the total weight of the composition. In certain embodiments, the polymeric composition comprises the second thermochromic pigment in an amount of greater than or equal to 0.1 wt. %, greater than or equal to 1 wt. %, greater than or equal to 2 wt. %, greater than or equal to 5 wt. %, or greater than or equal to 7 wt. % versus the total weight of the composition. According to some embodiments, the polymeric composition comprises the second thermochromic pigment in an amount of less than or equal to 10 wt. %, less than or equal to 7 wt. %, less than or equal to 5 wt. %, less than or equal to 2 wt. %, or less than or equal to 1 wt. % versus the total weight of the composition. Combinations of these ranges are also possible (e.g., the polymeric composition comprises the second thermochromic pigment in an amount of greater than or equal to 1 wt. % and less than or equal to 7 wt. % versus the total weight of the composition, the polymeric composition comprises the second thermochromic pigment in an amount of greater than or equal to 2 wt. % and less than or equal to 5 wt. % versus the total weight of the composition). Other ranges are also possible.

The polymeric composition may comprise the third thermochromic pigment in any of a variety of suitable amounts. For example, according to certain embodiments, the polymeric composition comprises the third thermochromic pigment in a range of 0.1 wt. % to 10 wt. % versus the total weight of the composition. In certain embodiments, the polymeric composition comprises the third thermochromic pigment in an amount of greater than or equal to 0.1 wt. %, greater than or equal to 1 wt. %, greater than or equal to 2 wt. %, greater than or equal to 5 wt. %, or greater than or equal to 7 wt. % versus the total weight of the composition. According to some embodiments, the polymeric composition comprises the third thermochromic pigment in an amount of less than or equal to 10 wt. %, less than or equal to 7 wt. %, less than or equal to 5 wt. %, less than or equal to 2 wt. %, or less than or equal to 1 wt. % versus the total weight of the composition. Combinations of these ranges are also possible (e.g., the polymeric composition comprises the third thermochromic pigment in an amount of greater than or equal to 0.1 wt. % and less than or equal to 7 wt. % versus the total weight of the composition, greater than or equal to 2 wt. % and less than or equal to 5 wt. % versus the total weight of the composition). Other ranges are also possible.

According to certain embodiments, the polymeric composition may comprise substantially the same amount of the first thermochromic pigment, the second thermochromic pigment, and/or the third thermochromic pigment (e.g., within 0.1 wt. %, within 0.2 wt. %, within 0.3 wt. %, within 0.4 wt. %, or within 0.5 wt. % vs. the total weight of the composition). For example, in a non-limiting embodiment, the polymeric composition may comprise 1 wt. % of the first thermochromic pigment vs. the total weight of the composition, 1 wt. % of the second thermochromic pigment vs. the total weight of the composition, and/or 1 wt. % of the third thermochromic pigment vs. the total weight of the composition. According to certain embodiments, the polymeric composition may comprise a different amount of the first thermochromic pigment, the second thermochromic pigment, and the third thermochromic pigment. For example, in a non-limiting embodiment, the polymeric composition may comprise 0.1 wt. % of the first thermochromic pigment vs. the total weight of the composition, 1 wt. % of the second thermochromic pigment vs. the total weight of the composition, and/or 3 wt. % of the third thermochromic pigment vs. the total weight of the composition. Other examples are also possible.

According to certain embodiments, the polymeric composition may comprise additional thermochromic pigments in addition to the first thermochromic pigment, the second thermochromic pigment, and the third thermochromic pigment (e.g., a fourth thermochromic pigment, a fifth thermochromic pigment, a sixth thermochromic pigment, etc.). For example, in certain embodiments, the polymeric composition comprises a fourth thermochromic pigment. According to certain embodiments, the additional thermochromic pigment (e.g., the fourth thermochromic pigment) may comprise myristyl, palm alcohol, 2,2-two (4-hydroxy-phenyl), latent dye, and/or melamine epoxy polymer. According to certain embodiments, additional thermochromic pigments (e.g., a fourth thermochromic pigment) are optional.

According to some embodiments, the additional thermochromic pigments function the same as the first thermochromic pigment, the second thermochromic pigment, and the third thermochromic pigment, as described herein. For example, in certain embodiments, the color of the polymeric composition changes from the fourth color to the fifth color as the temperature of the polymeric composition changes from the fourth temperature to the fifth temperature. In certain embodiments, the fifth temperature is greater than the fourth temperature, and the fifth color is different from the first color, second color, third color, and/or fourth color. According to certain embodiments, the color of the polymeric composition changes from the fifth color to the fourth color as the temperature of the composition changes from the fifth temperature to the fourth temperature.

In certain embodiments, the polymeric composition further comprises an additive. For example, the additive may comprise sand, starch (e.g., potato startch), flour, wax, clay minerals, oil (e.g., castor oil), salt (e.g. NaCl), silica, glycerol, calcium carbonate, oleic acid, titanium dioxide, an additional dye, a pigment, a colorant (e.g., alizarin, azo-pigments, phthalocyanine, quinacridone, ethylparaben, metal oxides, etc.), fragrances, glitter (e.g., gold glitter), a preservative, and/or combinations thereof. In certain embodiments, the polymeric composition may comprise small plastics, such as toys, charms, and/or beads Other additives are also possible. The polymeric composition may comprise the additive in any of a variety of suitable amounts.

In certain embodiments, the Inventors have realized that the compositions may comprise one or more of the additives listed above, resulting in various moldable compositions that are able to implement the color changes described herein. For example, in certain embodiments, the composition may comprise a polymer, water, borax, salt, and oil (e.g., moldable dough). In some embodiments, the composition may comprise sand and a silicone oil (e.g., moldable sand). According to certain embodiments, the composition may comprise a polymer and clay (e.g., moldable clay). The moldable dough, sand, and/or clay, in certain embodiments, may further comprise the first thermochromic pigment, second thermochromic pigment, and/or third thermochromic pigment (e.g., leuco dyes).

According to certain embodiments, the polymeric composition may be used for a variety of suitable applications. For example, according to certain embodiments, the polymeric composition may be used as a temperature indicator. In some embodiments, the polymeric composition may be used to indicate whether a certain product (e.g., a household cleaning product and/or a food product requiring a certain storage temperature) is being stored at a proper temperature (e.g., by using the composition as an indicator on the container of the product).

In some embodiments, the polymeric composition may be used in various beauty products (e.g., lipstick, makeup, nail polish, etc.) and/or hair products (e.g., hair dye, hair spray, etc.). According to certain embodiments, the polymeric composition can be incorporated into the beauty product and/or hair product and can cause color changes in the beauty and/or hair product depending on temperature, as described herein.

According to some embodiments, the polymeric composition may be used in paint, ink, and/or wallpaper. In certain embodiments, the polymeric composition may be incorporated into paint, ink, and/or wallpaper and can cause color changes in the paint, ink, and/or wallpaper depending on the temperature, as described herein.

In certain embodiments, the polymeric composition is used as a toy. According to certain embodiments, the polymeric composition may change color due to an exchange with thermal body heat (e.g., by holding the putty composition). Such polymeric compositions may be used as entertainment toys for children and/or stress toys for adults, for example.

Other applications related to color changing polymeric compositions are also possible in various industries, such as textile manufacturing, plastic manufacturing, and the like.

The following examples are intended to illustrate certain embodiments of the present invention, but do not exemplify the full scope of the invention.

### PROPHETIC EXAMPLE 1

The following prophetic example describes the synthesis of a polymeric composition comprising silicone oil and various thermochromic pigments. The polymeric composition may be synthesized by mixing dimethylsiloxane in an amount of 84 wt. %, boric acid in an amount of 0.005 wt. %, silica in an amount of 8 wt. %, calcium carbonate in an amount of 1.995 wt. %, oleic acid in an amount of 0.5 wt. %, gold glitter in an amount of 1.5 wt %, and a colorant in an amount of 4 wt. % versus the total weight of the polymeric composition. Following the synthesis of the polymeric composition, the polymeric composition may be doped with a red thermochromic pigment, a yellow thermochromic pigment, and a green thermochromic pigment by adding in 1 wt. % of each thermochromic pigment versus the total weight of the polymeric composition.

### PROPHETIC EXAMPLE 2

The following prophetic example describes the synthesis of a polymeric composition comprising organic polymers and various thermochromic pigments. The polymeric composition may be synthesized by mixing carboxyl methylcellulose in an amount of 12.5 wt. %, guar gum in an amount of 2.4 wt. %, glycerol in an amount of 0.72 wt. %, potato starch in an amount of 11 wt. %, silica in an amount of 5.78 wt. %, borax in an amount of 0.02 wt %, ethylparaben in an amount of 0.4 wt. %, and deionized water in an amount of 67.18 wt. % versus the total weight of the polymeric composition. Following the synthesis of the polymeric composition, the polymeric composition may be doped with a red thermochromic pigment, a yellow thermochromic pigment, and a green thermochromic pigment by adding in 1 wt. % of each thermochromic pigment versus the total weight of the polymeric composition.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, in a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, in a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A polymeric composition that has a first color at a first temperature, comprising:
a polymerized component, a first thermochromic pigment, a second thermochromic pigment, and a third thermochromic pigment;
wherein the first thermochromic pigment, second thermochromic pigment and/or third thermochromic pigment cause the polymeric composition to have a second color at a second temperature, a third color and a third temperature, and/or a fourth color at a fourth temperature.

2. The polymeric composition of claim 1, wherein the polymerized component comprises silicone oil.

3. The polymeric composition of claim 2 wherein the silicone oil comprises a siloxane.

4. The polymeric composition of claim 2, wherein the silicone oil is polydimethylsiloxane.

5. The polymeric composition of claim 2, wherein the silicone oil comprises dimethylsiloxane.

6. The polymeric composition of claim 1, wherein the polymeric composition comprises boric acid.

7. The polymeric composition of claim 1, wherein the polymeric composition is a silicone oil-based putty composition.

8. The polymeric composition of claim 2, wherein the composition comprises silicone oil in a range of 50 wt. % to 95 wt. % versus the total weight of the composition.

9. The polymeric composition of claim 1, wherein the polymerized component comprises an organic polymer.

10. The polymeric composition of claim 9, wherein the organic polymer comprises polyvinyl alcohol, polyvinyl acetate, polysaccharide guar gum, methylcellulose, cornstarch, and/or derivatives thereof.

11. The polymeric composition of claim 9, further comprising water.

12. The polymeric composition of claim 9, further comprising an initiator.

13. The polymeric composition of claim 12, wherein the initiator is sodium borate and/or sodium tetraborate.

14. The polymeric composition of claim 1, wherein the polymeric composition is a water-based slime composition.

15. The polymeric composition of claim 9, wherein the polymeric composition comprises the organic polymer in a range of 1 wt. % to 10 wt % versus the total weight of the composition.

16. The polymeric composition of claim 1, wherein the first thermochromic pigment, second thermochromic pigment, and/or third thermochromic pigment comprise myristyl, palm alcohol, 2,2-two (4-hydroxy-phenyl), latent dye, and/or melamine epoxy polymer.

17. The polymeric composition of claim 1, wherein the composition comprises the first thermochromic pigment in an amount of 1 wt. % to 10 wt. % versus the total weight of the composition.

18. The polymeric composition of claim 1 any preceding claim, wherein the composition comprises the second thermochromic pigment in an amount of 1 wt. % to 10 wt. % versus the total weight of the composition.

19. The polymeric composition of claim 1, wherein the composition comprises the third thermochromic pigment in an amount of 1 wt. % to 10 wt. % versus the total weight of the composition.

20. The polymeric composition of claim 1 any preceding claim, wherein the composition comprises a fourth thermochromic pigment.

21. The polymeric composition of claim 20, wherein the fourth thermochromic pigment comprises myristyl, palm alcohol, 2,2-two (4-hydroxy-phenyl), latent dye, and/or melamine epoxy polymer.

22. The polymeric composition of claim 1, wherein the polymeric composition further comprises an additive.

23. The polymeric composition of claim 22, wherein the additive comprises castor oil, clay, silica, glycerol, calcium carbonate, titanium dioxide, a dye, a fragrance, glitter, a preservative, and/or combinations thereof.

24. The polymeric composition of claim 1, wherein the color of the composition changes from the first color to the second color by changing the temperature of the composition from the first temperature to the second temperature.

25. The polymeric composition of claim 1, wherein the color of the composition changes from the second color to the third color by changing the temperature of the composition from the second temperature to the third temperature.

26. The polymeric composition of claim 1, wherein the color of the composition changes from the third color to the fourth color by changing the temperature of the composition from the third temperature to the fourth temperature.

27. The polymeric composition of claim 1, wherein the color of the composition changes from the fourth color to the third color by changing the temperature of the composition from the fourth temperature to the third temperature.

28. The polymeric composition of claim 1, wherein the color of the composition changes from the third color to the second color by changing the temperature of the composition from the third temperature to the second temperature.

29. The polymeric composition of claim 1, wherein the color of the composition changes from the second color to first color by changing the temperature of the composition from the second temperature to the first temperature.

30. The polymeric composition of claim 1, wherein the first thermochromic pigment, the second thermochromic pigment, and/or the third thermochromic pigment are leuco dyes.

31-32. (canceled)
